(19) United States
(12) Patent Application Publication
(10) Pub. No.: US 2026/0250071 A1
(43) Pub. Date: Aug. 27, 2026

(54) GOODS RETRIEVING OR PLACING DEVICE AND THREE-DIMENSIONAL GOODS TRANSPORTATION DEVICE

(71) Applicant: Hai Robotics Co., Ltd., Shenzhen (CN)

(72) Inventors: Kai Chen, Shenzhen (CN); Xiaolong Li, Shenzhen (CN); Yihua Ye, Shenzhen (CN)

(21) Appl. No.: 19/647,649

(22) Filed: Apr. 14, 2026

Related U.S. Application Data
(63) Continuation of application No. PCT/CN2024/124026, filed on Oct. 10, 2024.

(30) Foreign Application Priority Data
Nov. 24, 2023 (CN) 202323186984.0

(51) Int. Cl. B65G 1/04; B25J 9/00

(52) U.S. Cl. CPC B65G 1/0464; B25J 9/0078

(57) ABSTRACT

A goods retrieving or placing device includes a fork, four driving mechanisms that surround the fork and are higher than the fork, and ropes. Each rope corresponds to a corresponding one of the driving mechanisms. A top of each rope is connected to the corresponding driving mechanism. Bottoms of the ropes are connected to the fork to keep the fork in balance. The driving mechanisms are configured to control the ropes to be wound or unwound. Fixing members are mounted at the driving mechanisms and the driving mechanisms are configured to be mounted on an external component via the fixing members.

### CROSS-REFERENCES

The present application is a continuation of International Patent Application No. PCT/CN2024/124026 filed on October 10, 2024, which claims priority to Chinese Patent Application No. 202323186984.0, filed on November 24, 2023, which applications are incorporated herein by reference in their entireties.

### TECHNICAL FIELD

The present application relates to the technical field of stacker cranes and, in particular embodiments, to a goods retrieving or placing device and a three-dimensional goods transportation device.

### BACKGROUND OF THE INVENTION

In the related art, a stacker crane often operates to load goods onto racks or retrieve goods from racks in two modes: an Airrob mode and a traditional mother-child shuttle mode. In the Airrob mode, a stacker crane rail is fixed to one side of the rack, and power is supplied via a sliding contact line. A fork is suspended from a mast, and the mast slides along the rail. With the movement of the mast, the fork is moved to a corresponding storage bin. In the traditional mother-child shuttle mode, an autonomous case-handling robot (ACR) retrieves and stores storage bins; a mother shuttle travels along an aisle, employing a lifting mast solution; and a fork is mounted on the lifting mast, and the mother shuttle carries a battery.

Since upper and lower rails are used in the Airrob mode, the mast moves along the rails, causing high rail costs per meter. The rails require high installation precision within the racks, making implementation difficult. In addition, the Airrob mode relies on the sliding contact line for power supply, which not only increases costs but also poses challenges to maintaining the sliding contact line.

However, the ACR solution has a space-size problem. The movement of the mother shuttle can obstruct the travel of the child shuttle, resulting in low efficiency. The considerable weight of the fork and the mast further increase power and costs.

### SUMMARY

Embodiments disclosed herein can solve or partially solve the problems in the related art. For example, the present application provides an goods retrieving or placing device and a three-dimensional goods transportation device. A fork can be quickly moved to a specified position by controlling ropes, and the costs can be also reduced.

A first aspect of the present application provides a goods retrieving or placing device, including a fork, four driving mechanisms, ropes, and fixing members. The four driving mechanisms surround the fork and are higher than the fork. Each rope corresponds to one driving mechanism. The top of each rope is connected to a corresponding driving mechanism, and bottoms of the ropes are connected to the fork to keep the fork in balance. The driving mechanisms are configured to control the ropes to be wound or unwound. The fixing members are mounted at the driving mechanisms, and the driving mechanisms are mounted on an external component via the fixing members.

In some embodiments, the four driving mechanisms are located at a same height.

In some embodiments, the four driving mechanisms are distributed in a rectangular pattern.

In some embodiments, the number of the ropes is four. The fork is suspended from bottom ends of the ropes and connection points of the fork and the four ropes are distributed in a rectangular pattern.

In some embodiments, the number of the ropes is two. Two ends of each rope are respectively connected to two of the driving mechanisms; and the bottoms of the ropes support the fork.

In some embodiments, the ropes are steel wire ropes.

A second aspect of the present application provides a three-dimensional goods transportation device, including two racks and the goods retrieving or placing device. The two racks are arranged in parallel. The fork is located between the two racks. The driving mechanisms are mounted at the racks via the fixing members. Two of the driving mechanisms are mounted at each rack. Compartments for receiving and delivering cargo are arranged on the racks. The driving mechanisms control the winding and unwinding of the ropes to allow the fork to be aligned with any compartment.

In some embodiments, the driving mechanisms are mounted on one surface of one rack facing the other rack, and the driving mechanisms are located at corners of the racks.

In some embodiments, highest points of the ropes are higher than the compartments.

In some embodiments, the compartments are located between the two driving mechanisms on the same rack.

Technical solutions provided in the present application can have a number of beneficial effects. The driving mechanisms wind or unwind the ropes, and the ropes drive the fork to move, so that the fork can be quickly moved to a specified position, and there is no need to arrange rails and sliding contact lines on site. This reduces installation costs. In addition, compared with a mode for supplying power by using the sliding contact lines, this mode allows easier maintenance of the driving mechanisms and the ropes, and further reduces costs. Since the fork is overhead and does not occupy a ground space, a space utilization rate is improved. Moreover, the movement of the fork is not affected by the travel of a child shuttle, thereby improving the efficiency of loading and unloading operation.

It should be understood that the foregoing general descriptions and the following detailed descriptions are merely for illustration and explanation purposes and are not intended to limit the present application.

### BRIEF DESCRIPTION OF DRAWINGS

The exemplary implementations of the present application will be described in more details with reference to the accompanying drawings. The above and other objectives, features, and advantages of the present application will become more obvious. In the exemplary implementations of the present application, the same reference numerals generally represent the same components.

FIG. 1 is a schematic structural diagram of a goods retrieving or placing device according to an embodiment of the present application;

FIG. 2 is another schematic structural diagram of a goods retrieving or placing device according to an embodiment of the present application;

FIG. 3 is a top view of a goods retrieving or placing device according to an embodiment of the present application;

FIG. 4 is a side view of a goods retrieving or placing device according to an embodiment of the present application;

FIG. 5 is a side view of a goods retrieving or placing device according to another embodiment of the present application;

FIG. 6 is a schematic structural diagram of a driving mechanism according to an embodiment of the present application; and

FIG. 7 is a top view of the fork and the rope according to an embodiment of the present application.

The following numerals are provided in the accompanying drawings: 1- fork; 11- connection point; 2- driving mechanism; 21- reel; 22- pulley groups; 3- rope; 31- top; 32- bottom end; 4- rack; 5- compartment; 6- buffer pallet; 7- fixing member; and 8- H-shaped pulley.

### DETAILED DESCRIPTION

The implementations of the present application will be described in more detail below with reference to the accompanying drawings. Although the accompanying drawings show the implementations of the present application, it should be understood that the present application can be implemented in various forms and should not be limited to the implementations stated herein. Rather, these implementations are provided for understanding the present application more thoroughly and completely, and can completely transfer the scope of the present application to those skilled in the art.

It should be understood that although various information may be described using terms such as "first," "second," and "third" in the present application, such information should not be limited to these terms. These terms are only used to distinguish information of the same type from each other. For example, without departing from the scope of the present application, first information can also be referred to as second information, and similarly, second information can also be referred to as first information. Thus, features defined as "first" and "second" explicitly or implicitly include one or more of the features. In the descriptions of the present application, "a plurality of" means two or more, unless otherwise definitely and specifically limited.

In the descriptions of the present application, it should be understood that orientations or positional relationships indicated by the terms "length," "width," "upper," "lower," "front," "rear," "left," "right," "vertical," "horizontal," "top," "bottom," "inner," "outer," and the like are orientations or positional relationships as shown in the drawings, and are only for the purpose of facilitating and simplifying the descriptions of the present application instead of indicating or implying that devices or elements indicated must have particular orientations, and be constructed and operated in the particular orientations, so that these terms are not construed as limiting the present application.

Unless otherwise expressly specified and limited, the terms "mount," "connect," "connection," "fix" and the like should be understood in a broad sense, such as, a fixed connection, a detachable connection, an integrated connection, a mechanical connection, an electrical connection, a direct connection, an indirect connection through an intermediate medium, an internal communication of two elements, or interaction between two elements. Those of ordinary skill in the art can understand the specific meanings of the above terms in this application according to specific situations.

For the above problems, an embodiment of the present application provides a goods retrieving or placing device. A fork can be quickly moved to a specified position by controlling ropes, and the costs can be also reduced.

The following provides a detailed description to the technical solution of this embodiment of the present application with reference to the accompanying drawings.

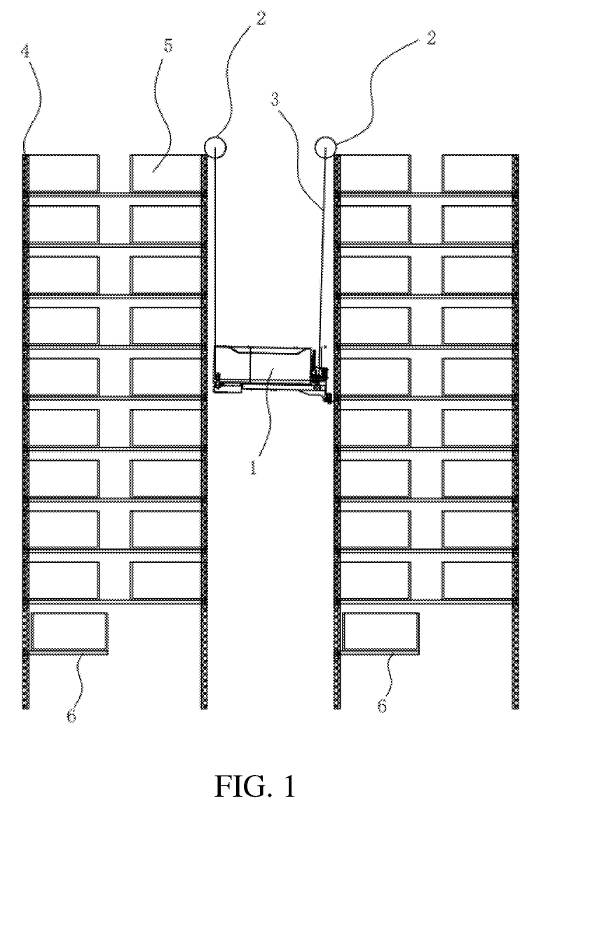

FIG. 1 is a schematic structural diagram of a goods retrieving or placing device according to an embodiment of the present application.

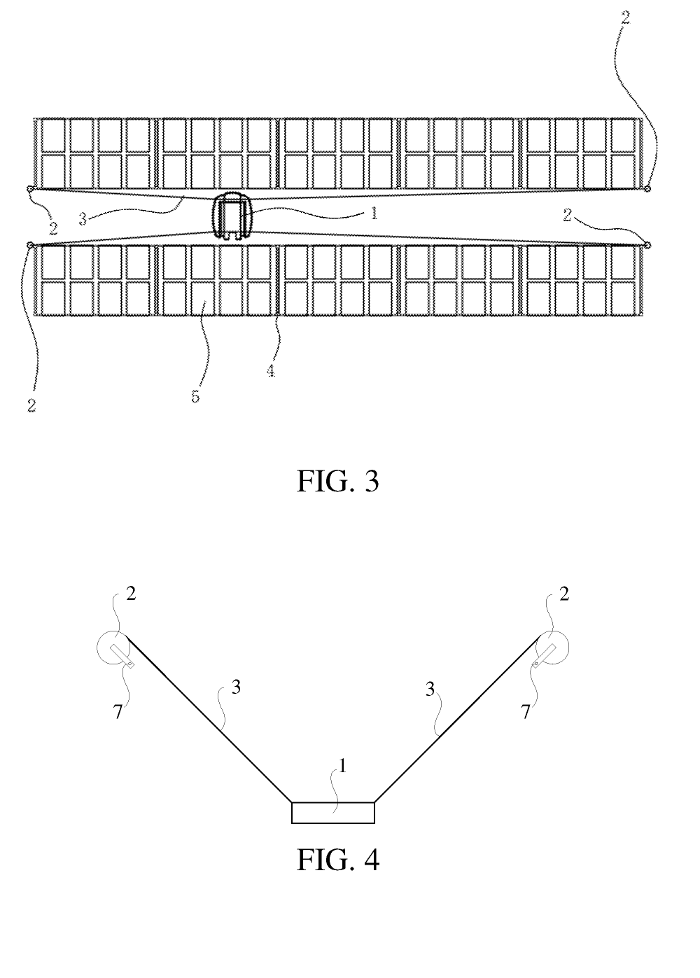

Referring to FIG. 1 and FIG. 3, a goods retrieving or placing device includes a fork 1, four driving mechanisms 2, ropes 3, and fixing members 7. The fork 1 can convey goods forward or backward or can retrieve cargo forward or backward. That is, the fork 1 can place goods to, or retrieve goods from, positions in two opposite sides of the fork 1. The four driving mechanisms 2 are distributed in a quadrilateral pattern and surround the fork 1. The driving mechanisms 2 are higher than the fork 1. Each driving mechanism 2 includes a servo motor and a reel for winding or unwinding each rope 3. The servo motor controls rotation of the reel. It can be understood that, the number of the driving mechanisms can be less than or more than four, as long as they can drive the fork to move and maintain the balance of the fork.

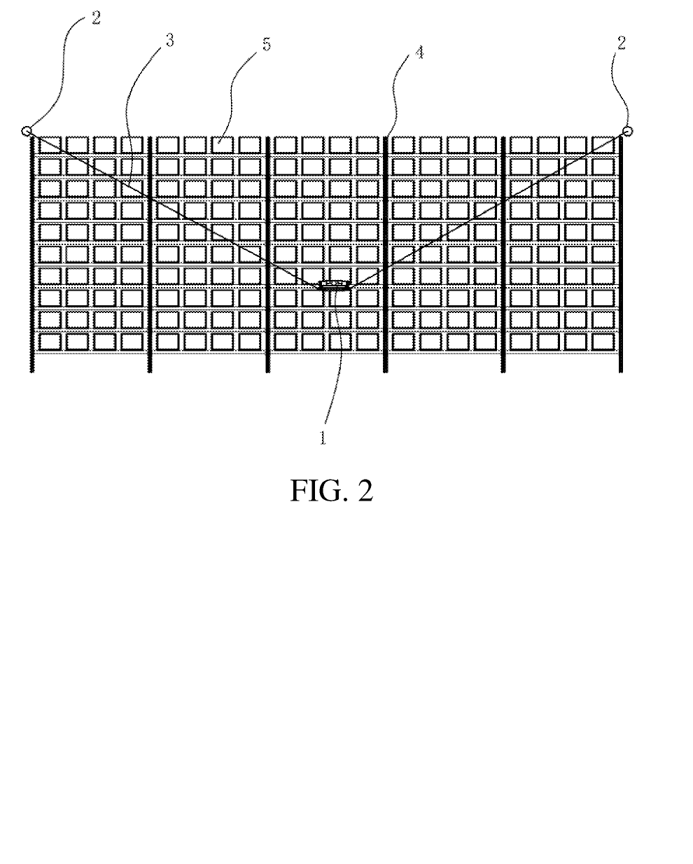

FIG. 2 is another schematic structural diagram of a goods retrieving or placing device according to an embodiment of the present application.

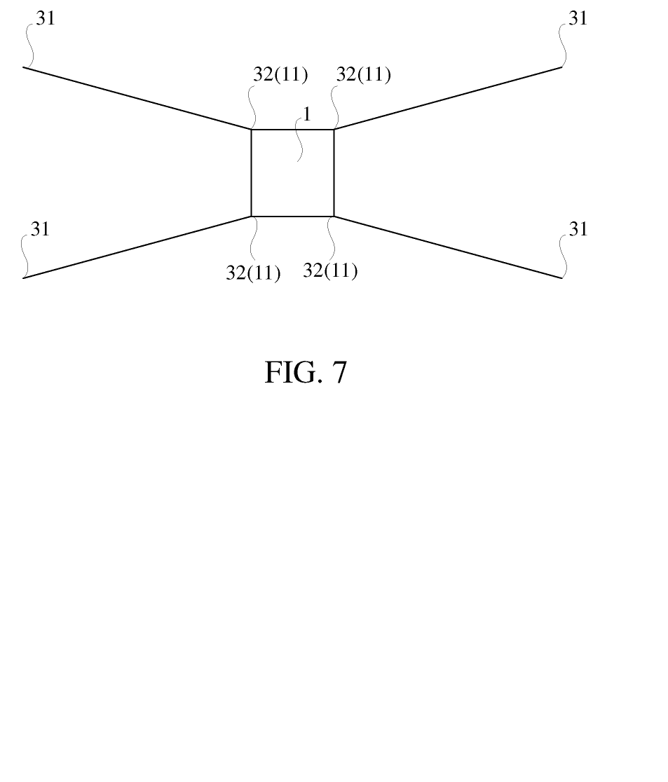

Referring to FIG. 1 to FIG. 2, there are four ropes 3. For each rope 3, an end of the rope 3 corresponds to one driving mechanism 2. As shown in FIG. 4 and FIG. 7, tops 31 of the ropes 3 are connected to the driving mechanisms 2, for example, for each rope 3, a higher end of the rope 3 is connected to one driving mechanism 2, and the driving mechanisms 2 control the ropes 3 to be wound or unwound. Specifically, the top end of each rope 3 is wound on the reel. When the driving mechanism 2 drives the reel to rotate, the reel can unwind or wind the rope 3. A bottom end 32 of each rope 3 is connected to the fork 1. The ropes 3 are steel wire ropes and are light in weight and low in cost. The driving mechanisms 2 can employ low-power motors to wind and unwind the steel wire ropes. A point where the ropes 3 first contact the fork 1 after exiting from the driving mechanisms 2 is defined as a contact point. Each driving mechanism 2 corresponds to one contact point, and at least three of the four contact points are non-collinear to ensure that the fork 1 remains balanced when driven by the driving mechanisms 2 via the ropes 3. The fixing members 7 are mounted on the driving mechanisms 2, and the driving mechanisms 2 are mounted on an external component via the fixing members 7.

In this embodiment, the external component is a rack 4. In some other embodiments, the external component is a ceiling of a warehouse. In some other embodiments, the external component is a guide rail fixed above the rack 4. The guide rail is arranged above a plurality of racks 4 that are arranged in parallel. The driving mechanisms 2 can be mounted on the guide rail via the fixing members and can slide in a length direction of the guide rail. In this way, the fork 1 can be transferred between the plurality of racks 4 that are arranged in parallel. The fixing members 7 are bolts, nails, brackets, sliding blocks, and other parts that can indirectly fix other external components. If the external component is the rack 4, the fixing members can be bolts, and the driving mechanisms 2 are fixed to the rack 4 through the bolts. If the external component is the ceiling of the warehouse, the fixing members can be nails, and the driving mechanisms 2 are fixed to the ceiling of the warehouse through the nails.

In an actual working process, when the fork 1 needs to be lifted, the four driving mechanisms 2 simultaneously wind the ropes 3, and the ropes 3 can drag the fork 1 upward. To move the fork 1 diagonally upward, two driving mechanisms 2 in a direction in which the fork 1 needs to be moved forward wind the ropes 3 at a higher speed, and the other two driving mechanisms 2 wind the ropes 3 at a lower speed. To lower the fork 1, the four driving mechanisms 2 simultaneously unwind the ropes 3. To control the fork 1 to move diagonally downward, two driving mechanisms 2 are controlled to unwind the ropes 3 at a higher speed, and the other two driving mechanisms 2 are controlled to unwind the ropes 3 at a lower speed. The driving mechanisms 2 wind or unwind the ropes 3, and the ropes 3 drive the fork 1 to move, so that the fork 1 can be quickly moved to a specified position, and there is no need to arrange rails and sliding contact lines on site. This reduces installation costs. In addition, compared with a mode for supplying power by using the sliding contact lines, this mode allows easier maintenance of the driving mechanisms 2 and the ropes 3 and further reduces costs. Since the fork 1 is overhead and does not occupy a ground space, a space utilization rate is improved. The movement of the fork 1 is not affected by the travel of a child shuttle, thereby improving the efficiency of loading or unloading operation.

Referring to FIG. 1 to FIG. 2, in this embodiment, the four driving mechanisms 2 are located at the same height and are distributed in a rectangular pattern. This configuration facilitates calculation of an amount of the ropes 3 required to be wound or unwounded by the driving mechanisms 2 during the movement of the fork 1 and also makes it convenient for the four driving mechanisms 2 to cooperate with each other to adjust an amount of winding or unwinding of the ropes 3. In some other embodiments, for some external components with different heights, such as racks 4 with different heights, the driving mechanisms 2 can also be mounted at tops of the racks 4, and each rack 4 corresponds to one driving mechanism 2. In this case, although the heights of the four driving mechanisms 2 are different, the driving mechanisms 2 can still adjust a position of the fork 1 by winding or unwinding the ropes 3.

Referring to FIG. 1 to FIG. 2, in an embodiment, four ropes 3 are included, and the fork 1 is suspended from bottom ends of the ropes 3. Connection points 11 of the fork 1 and the four ropes 3 are distributed in a rectangular pattern. Specifically, the bottom ends of the ropes 3 form contact points with the fork 1, and the four contact points are distributed in a rectangular pattern. When the driving mechanisms 2 drive the fork 1 to move through the ropes 3, the fork 1 remains balanced, and this configuration facilitates calculation of the amount of the ropes 3 required to be wound or unwounded by the driving mechanisms 2 during the movement of the fork 1.

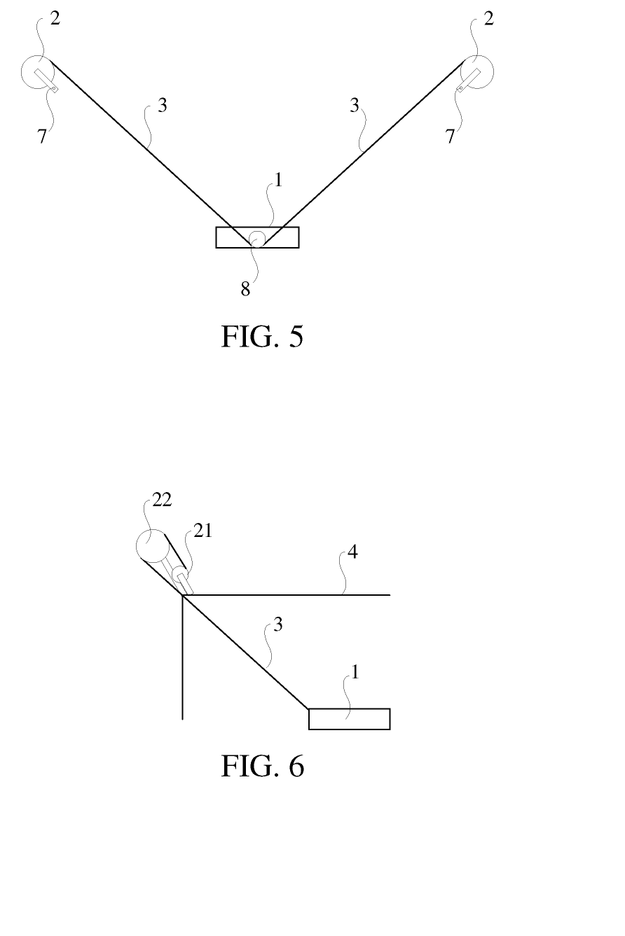

In an embodiment, referring to FIG. 5, two ropes 3 are included. Each rope 3 is roughly U-shaped. Two ends of each rope 3 are connected to two driving mechanisms 2 respectively. Bottoms of the ropes 3 support the fork 1. An example in which the external component is the rack 4 is used. On the same rack 4, one end of each rope 3 is connected to one of the driving mechanisms 2, and the other end of the rope 3 is connected to the other driving mechanism 2. The U-shaped bottom of the rope 3 supports the fork 1. Specifically, an H-shaped pulley 8 is arranged at a bottom of the fork 1 and can slide along the rope 3. When the driving mechanisms 2 wind the rope 3, the fork 1 is lifted and slides along the rope 3, thereby achieving linear vertical uplift or diagonal upward movement of the fork 1.

FIG. 3 is a top view of a goods retrieving or placing device according to an embodiment of the present application.

Referring to FIG. 1 to FIG. 3, corresponding to the foregoing device embodiment for implementing an application function, the present application further provides a three-dimensional goods transportation device and a corresponding embodiment. The three-dimensional goods transportation device includes at least two racks 4 and a goods retrieving or placing device. The two racks 4 are arranged in parallel. A fork 1 is located between the two racks 4. Driving mechanisms 2 are mounted at the racks 4 via fixing members 7. Each rack 4 is provided with two driving mechanisms 2. Compartments 5 for receiving and delivering goods or for storing goods are arranged on the racks 4. The driving mechanisms 2 control the winding or unwinding of the ropes 3 to allow the fork 1 to be aligned with any compartment 5.

In some embodiments, the driving mechanisms 2 are mounted on one surface of one rack 4 facing the other rack 4, and the driving mechanisms 2 are located at corners of the racks 4. The four driving mechanisms 2 are distributed in a rectangular pattern and are arranged at the corners of the racks 4. This configuration ensures that the driving mechanisms 2 can move the fork 1 to a compartment 5 at the corner of each rack 4 through the ropes 3 and align the fork 1 with the compartment 5 at the corner of the rack 4.

In some embodiments, the compartments 5 are located between the two driving mechanisms 2 on the same rack 4, to ensure that the driving mechanisms 2 can move, through the ropes 3, the fork 1 to a compartment 5 of the rack 4 close to a side edge and align the fork 1 with the compartment 5 of the rack 4 close to the side edge.

In some embodiments, referring to FIG. 6, each driving mechanism 2 further includes a pulley group 22. A servo motor can be mounted at any position of the rack 4. After the ropes 3 are output from a reel 21, the ropes 3 are redirected by the pulley groups 22 and then reach the fork 1. The pulley groups 22 are higher than the fork 1 and the compartments 5. Highest points of the ropes 3 are located at the pulley groups 22, and the highest points of the ropes 3 are higher than the compartments 5.

Referring to FIG. 1 and FIG. 3, in this embodiment, the driving mechanisms 2 can control the fork 1 to move vertically upward or downward in a straight line or control the fork 1 to move diagonally upward or downward. A distance between the fork 1 and each rack 4 is less than 50 cm. After being aligned with a compartment 5, the fork 1 can push goods on the fork 1 across a gap between the fork 1 and the rack 4 into the compartment 5. In other embodiments, a distance between the fork 1 and each rack 4 may not be limited. The driving mechanisms 2 can control the fork 1 to move forward toward or backward away from the rack 4 via the ropes 3. Specifically, the two driving mechanisms 2 on the same rack 4 can wind the ropes 3 to pull the fork 1 toward the rack 4 in which the two driving mechanisms 2 are located, causing the fork 1 to move forward toward one of the racks 4. Conversely, when other two driving mechanisms 2 on the other rack 4 wind the ropes 3, the fork 1 can move backward.

Referring to FIG. 1, in some embodiments, in order to facilitate transportation of goods, each rack 4 is further provided with a buffer pallet 6. The buffer pallet 6 is located below the compartments 5. When goods in the compartment 5 needs to be transported out of the goods retrieving or placing device, the driving mechanisms 2 can control the fork 1 to move to the corresponding compartment 5 and then retrieve the goods from the compartment 5. The driving mechanisms 2 then control the fork 1 to move to the buffer pallet 6, and the fork 1 pushes the goods onto the buffer pallet 6. The driving mechanisms 2 control the fork 1 to return to its original position, and then an external automatic guided vehicle (AGV) moves to the buffer pallet 6 to retrieve the goods on the buffer pallet 6 and transport the goods to an external workstation. In addition, the buffer pallet 6 can also be used as a transition zone for inputting goods to the goods retrieving or placing device. Specifically, when goods need to be placed into the compartment 5 from the outside, the external AGV can transport the goods to the buffer pallet 6. The driving mechanisms 2 control the fork 1 to move to the buffer pallet 6. The fork 1 retrieves the goods. The driving mechanisms 2 then control the fork 1 to move to the designated compartment 5. Then, the fork 1 pushes the goods into the corresponding compartment 5. Preferably, in order to facilitate the external AGV in lifting cargo on the buffer pallet 6, the buffer pallet 6 is provided with a plurality of hollow holes. The external AGV can lift the goods through the hollow holes and then transfer the goods from an upper side of the buffer pallet 6.

The solutions of the present application have been described in detail above with reference to the accompanying drawings. In the foregoing embodiments, the description of each embodiment has respective focuses. For a part that is not described in detail in an embodiment, reference may be made to related descriptions in other embodiments. Those skilled in the art should also be aware that the actions and modules involved in this specification may not be necessary for the present application. Furthermore, it can be understood that the steps in the method of the embodiments of the present application can be sequentially adjusted, merged, and deleted according to actual needs. The modules in the device of the embodiments of the present application can be merged, partitioned, and deleted according to actual needs.

The above has described the various embodiments of the present application. The above explanation is exemplary, not exhaustive, and is not limited to the various embodiments disclosed herein. Many modifications and changes are obvious to those of ordinary skill in the art without deviating from the scope and spirit of the various embodiments described herein. The selection of the terms used herein aims to best explain the principles and practical applications of the various embodiments or improvements to technologies in the market, or to

enable other persons of ordinary skill in the art to understand the various embodiments disclosed herein.

1. A goods retrieving or placing device, comprising: a fork; four driving mechanisms that surround the fork and are higher than the fork; a plurality of ropes, wherein each rope corresponds to a corresponding one of the driving mechanisms, wherein a top of each rope is connected to the corresponding driving mechanism, wherein bottoms of the ropes are connected to the fork to keep the fork in balance, and wherein the driving mechanisms are configured to control the ropes to be wound or unwound; and a plurality of fixing members mounted at the driving mechanisms, the driving mechanisms configured to be mounted on an external component via the fixing members.

2. The goods retrieving or placing device according to claim 1, wherein the four driving mechanisms are located at the same height.

3. The goods retrieving or placing device according to claim 2, wherein the four driving mechanisms are distributed in a rectangular pattern.

4. The goods retrieving or placing device according to claim 1, wherein the plurality of ropes consists of four ropes, the fork being suspended from bottom ends of the ropes, wherein connection points of the fork and the four ropes are in a rectangular pattern.

5. The goods retrieving or placing device according to claim 1, wherein the plurality of ropes consists of two ropes, two ends of each rope being respectively connected to two of the driving mechanisms such that the bottoms of the ropes support the fork.

6. The goods retrieving or placing device according to claim 1, wherein the ropes comprise steel wire ropes.

7. A three-dimensional goods transportation device, comprising: first and second racks; and a goods retrieving or placing device comprising a fork, four driving mechanisms, a plurality of ropes, and a plurality of fixing members; wherein the four driving mechanisms surround the fork and are higher than the fork; wherein each rope corresponds to one driving mechanism; wherein tops of the ropes are connected to a corresponding driving mechanism respectively; wherein bottoms of the ropes are connected to the fork to keep the fork in balance; wherein the driving mechanisms are configured to control the ropes to be wound or unwound; wherein the fixing members are mounted at the driving mechanisms; wherein the driving mechanisms are configured to be mounted on an external component via the fixing members; wherein the first and second racks are arranged in parallel; wherein the fork is located between the first and second racks; wherein the driving mechanisms are mounted at the racks via the fixing members; wherein two of the driving mechanisms are mounted at each rack; wherein compartments for receiving and delivering goods are arranged on the racks; and wherein the driving mechanisms are configured to control winding and unwinding of the ropes to allow the fork to be aligned with any compartment.

8. The three-dimensional goods transportation device according to claim 7, wherein the driving mechanisms are mounted on one surface of the first rack facing the second rack and wherein the driving mechanisms are located at corners of the racks.

9. The three-dimensional goods transportation device according to claim 7, wherein highest points of the ropes are higher than the compartments.

10. The three-dimensional goods transportation device according to claim 7, wherein the compartments are located between two driving mechanisms on the same rack.

11. The three-dimensional goods transportation device according to claim 7, wherein the four driving mechanisms are located at the same height.

12. The three-dimensional goods transportation device according to claim 11, wherein the four driving mechanisms are distributed in a rectangular pattern.

13. The three-dimensional goods transportation device according to claim 7, wherein the plurality of ropes consists of four ropes, the fork being suspended from bottom ends of the ropes, wherein connection points of the fork and the four ropes are in a rectangular pattern.

14. The three-dimensional goods transportation device according to claim 7, wherein the plurality of ropes consists of two ropes, two ends of each rope being respectively connected to two of the driving mechanisms such that the bottoms of the ropes support the fork.

15. The three-dimensional goods transportation device according to claim 7, wherein the ropes comprise steel wire ropes.

16. A goods retrieving or placing device, configured to retrieve or place goods from or to a storage position in a rack, the goods retrieving or placing device comprising: a fork; a driving mechanism configured to drive the fork to move relative to the rack such that the fork is capable of aligning with the storage position; and a rope connected to the fork and the driving mechanism, wherein the driving mechanism is configured to drive the fork through the rope.

17. The goods retrieving or placing device according to claim 16, wherein there are four driving mechanisms, the four driving mechanisms being arranged at the same height.

18. The goods retrieving or placing device according to claim 17, wherein the four driving mechanisms are distributed in a rectangular pattern.

19. The goods retrieving or placing device according to claim 17, wherein there are four ropes and wherein, for each rope, an end of the rope is connected to a respective one of the driving mechanisms, an other end of each rope being connected to the fork.

20. The goods retrieving or placing device according to claim 17, wherein there are two ropes and wherein, for each rope, two ends of the rope are connected to two driving mechanisms respectively, a middle portion of the rope being slidably connected to the fork.
